(19) United States
(12) Patent Application Publication
(10) Pub. No.: US 2012/0317002 A1
(43) Pub. Date: Dec. 13, 2012

(54) ACCOUNTING APPARATUS, IMAGE FORMING DEVICE, AND ACCOUNTING METHODS THEREOF

(75) Inventors: Chang-nam YOU, Gyeongsangbuk-do (KR); Sang-woo PARK, Suwon-si (KR)

(73) Assignee: Samsung Electronics Co., Ltd., Suwon-si (KR)

(21) Appl. No.: 13/332,963

(22) Filed: Dec. 21, 2011

(30) Foreign Application Priority Data
Jun. 7, 2011 (KR) 10-2011-0054731

(51) Int. Cl. G06Q 10/00

(52) U.S. Cl. 705/30

(57) ABSTRACT

An accounting method for an image forming device is provided, which includes installing an accounting application, an accounting manager provided on a platform of the image forming device storing information on the installed accounting application in a storage unit, displaying information on the whole accounting applications stored in the storage unit if a start command for an image forming job is input, receiving a selection of one accounting application among the displayed information, performing the image forming job if it is possible for the selected accounting application to perform accounting for the image forming job, and performing the accounting according to an accounting policy of the selected accounting application if the image forming job is completed.

### CROSS-REFERENCE TO RELATED APPLICATIONS

This application claims priority under 35 U.S.C. §119(a) to Korean Patent Application No. 10-2011-0054731, filed on Jun. 7, 2011, in the Korean Intellectual Property Office, the disclosure of which is incorporated herein by reference.

### BACKGROUND

1. Field

The present general inventive concept relates generally to an accounting apparatus, an image forming device, and accounting methods thereof, and more particularly, to an accounting apparatus, an image forming device, and accounting methods thereof, which can perform accounting using an accounting application.

2. Description of the Related Art

With the advancement of electronic technology, diverse kinds of electronic appliances have been developed. Recently, as the use of small-sized portable appliances, such as smart phones is rapidly increasing, various kinds of images photographed using such portable appliances have been frequently printed through image forming devices.

Such printing may be performed using a general image forming device, or may be performed using an image forming device specialized in photo printing or the like, in consideration of the specifications of the printing papers or toner. In this case, an appropriate accounting is performed according to the degree of use of the corresponding image forming device.

Recently, accounting programs have been installed to perform accounting according to the degree of use of the image forming device for image forming devices that are publically accessible and available for use by large quantities of people.

Typically, accounting programs are built into platforms of the image forming devices. Accordingly, new accounting policies may not be applied to the image forming devices unless the particular platform is changed.

### SUMMARY

The present general inventive concept has been made to address at least the above problems and/or disadvantages and to provide at least the advantages described below. Accordingly, an aspect of the present general inventive concept provides an accounting apparatus, an image forming device, and an accounting method thereof, which can separately install and use an accounting application.

Additional aspects and advantages of the present general inventive concept will be set forth in part in the description which follows and, in part, will be obvious from the description, or may be learned by practice of the general inventive concept.

According to an exemplary embodiment of the present general inventive concept, an accounting method for an image forming device includes storing information on the installed accounting application in a storage unit by an accounting manager provided on a platform of the image forming device, displaying information corresponding to the accounting applications stored in the storage unit and receiving a selection of one accounting application from among the displayed information corresponding to the accounting applications installed in the image forming device and performing an accounting operation for an image forming job according to an accounting policy of the selected accounting application upon the performance of the image forming job.

Here, the displaying information and the receiving the selection may be performed upon the initialization of the image forming job starts, and the accounting operation is performed in the selected accounting application upon the determination that the accounting operation for the image forming job is possible.

Here, the accounting manager may provide information on the image forming job through an interface that is defined in the accounting application, to provide confirmation from the accounting application that the accounting for the image forming job is possible.

Here, the interface may define at least one parameter among a first parameter reporting whether the present mode is a color mode or a mono mode, a second parameter reporting whether the present mode is a simplex mode or a duplex mode, a third parameter reporting a job type, and a fourth parameter reporting a print medium size.

On the other hand, the step of performing the image forming job may include the accounting manager delivering at least one parameter value that is included in the interface to the selected accounting application; the selected accounting application determining whether the accounting operation for the image forming job is possible on the basis of the at least one parameter value and reporting the result of the determination to the accounting manager; and if it is determined that the accounting operation is possible, providing output count information to the selected accounting application during performance of the image forming job, and if it is determined that the accounting operation is not possible, canceling the image forming job.

According to another exemplary embodiment of the present general inventive concept, an accounting method for an image forming device includes displaying information correspond to at least one accounting application installed to an external location located outside of a platform built in the image forming device; performing an image forming job following selection of an accounting application from among the displayed information correspond to the accounting application; and performing accounting according to an accounting policy of the selected accounting application.

Here, the step of performing the image forming job may include the selected accounting application confirming whether the accounting operation for execution of an option of the image forming job is possible by providing at least one parameter value to the selected accounting application according to the option of the image forming job; and if the accounting operation is possible, performing the image forming job, and if the accounting is not possible, canceling the image forming job.

Further, the step of performing the image forming job may include the selected accounting application confirming whether the accounting operation for execution of an option of the image forming job is possible by providing at least one parameter value to the selected accounting application according to the option of the image forming job; and if the accounting is possible, performing the image forming job, and if the accounting is not possible, receiving a reselection following the display of information corresponding to other accounting applications while excluding the display of the selected accounting application.

On the other hand, the parameter may include at least one parameter among a first parameter reporting whether the present mode is a color mode or a mono mode, a second parameter reporting whether the present mode is a simplex mode or a duplex mode, a third parameter reporting a job type, and a fourth parameter reporting a size of outputs.

According to another exemplary embodiment of the present general inventive concept, an image forming device includes a memory unit to store a platform of the image forming device and if at least one accounting application is installed separately from the platform, storing the installed accounting application; a display unit to display information corresponding to accounting applications stored in the memory unit and to receive a selection of one accounting application from among the displayed information corresponding to the account applications; an image forming unit to perform an image forming job ; and a control unit to perform accounting operations according to an accounting policy of the selected accounting application upon completion of the image forming job.

Here, the control unit may confirm whether the selected accounting application can perform the accounting operation for the image forming job if a start command for the image forming job is input, and may perform the accounting while performing the image forming job if the accounting operation is possible.

According to another exemplary embodiment of the present general inventive concept, an image forming device includes a first storage unit to store a plurality of accounting applications and an accounting manager for supporting the plurality of accounting application; wherein the accounting manager program performs an accounting for an image forming job using the accounting application selected among the plurality of accounting applications upon performance of the image forming job.

Here, the accounting manager program may provide information on the image forming job using an interface that is defined in the selected accounting application, confirm whether the selected accounting application can perform the accounting operation for the image forming job, and if the accounting is possible, providing output count information to the selected accounting application upon completion of the image forming job.

On the other hand, the accounting manager may deliver at least one parameter value that is defined in the interface to the selected accounting application; and the selected accounting application may determines whether the accounting operation for the image forming job is possible on the basis of the at least one parameter value and reports the result of the determination to the accounting manager.

Here, the at least one parameter may include at least one of a first parameter reporting whether the present mode is a color mode or a mono mode, a second parameter reporting whether the present mode is a simplex mode or a duplex mode, a third parameter reporting a job type, and a fourth parameter reporting a print medium size.

According to another exemplary embodiment of the present general inventive concept, a computer-readable recording medium for storing a program code for executing an accounting method for an image forming device may be provided.

Here, the accounting method includes storing an installed accounting application if an accounting application is installed separately from a platform of the image forming device; displaying information on the installed accounting application and previously stored accounting applications upon initialization of an image forming job starts; confirming whether an accounting operation for the image forming job is possible following selection of an accounting application among the displayed information corresponding to the installed accounting application and the previously stored accounting applications; performing the image forming job upon a determination that the accounting operation is possible; and performing the accounting operation according to an accounting policy of the selected accounting application upon completion of the image forming job.

Here, the step of confirming whether the accounting is possible may include an accounting manager built in the platform delivering at least one parameter value that is defined in an interface of the selected accounting application to the selected accounting application; and the selected accounting application deciding whether the accounting for the image forming job is possible on the basis of the at least one parameter value and reporting the result of decision to the accounting manager program; wherein the at least one parameter includes at least one of a first parameter reporting whether the present mode is a color mode or a mono mode, a second parameter reporting whether the present mode is a simplex mode or a duplex mode, a third parameter reporting a job type, and a fourth parameter reporting a print medium size.

According to another exemplary embodiment of the present general inventive concept, an accounting method for an image forming device may include installing and storing a plurality accounting applications in the image forming device; displaying information corresponding to the plurality of accounting applications; selecting a first accounting application from among the displayed information corresponding to the plurality of accounting applications; determining whether a first accounting operation may be performed for the selected first accounting application; and performing the first accounting operation according to an accounting policy of the selected first accounting application upon the determination that the first accounting operation may be performed and upon performance of an image forming job.

Here, if it is determined that the first accounting operation may not be performed, information corresponding to the plurality of accounting applications may be redisplayed while the information corresponding to the selected first accounting application is excluded.

Further, the accounting method may also include selecting of a second accounting application from among the redisplayed information corresponding to the plurality of accounting applications excluding the first accounting application; determining whether a second accounting operation may be performed for the selected second accounting application; and performing the second accounting operation according to an accounting policy of the selected second accounting application upon the determination that the second accounting operation may be performed and upon performance of the image forming job.

In the case where it is determined that the first accounting operation may not be performed, the image forming job may be canceled.

According to another exemplary embodiment of the present general inventive concept, an accounting method for an image forming device may include: installing and storing a plurality accounting applications in the image forming device; searching for accounting applications among the plurality of stored accounting applications having corresponding accounting operations capable of being performed; determining, based on the searching among the plurality of stored accounting applications, a number of the accounting applications among the plurality of stored accounting applications having corresponding accounting operations capable of being performed; selecting an accounting application from among the plurality of stored accounting applications having corresponding accounting operations capable of being performed; and performing an accounting operation corresponding to the selected accounting application according to an accounting policy of the selected accounting application following performance of an image forming job.

Here, if it is determined that at least two accounting applications among the plurality of stored accounting applications having corresponding accounting operations are capable of being performed, information corresponding to the at least two accounting applications may be displayed. In this case, the selecting of the account application is from among the at least two accounting applications.

Conversely, if it is determined that a single accounting application among the plurality of stored accounting applications is capable of being performed, the displaying of the information is omitted and the accounting application from among the plurality of stored account applications is automatically selected.

Further, if is determined that no accounting application among the plurality of stored accounting applications is capable of being performed, the image forming job may be canceled.

According to the various exemplary embodiments of the present general inventive concept as described above, the additional accounting application can be readily installed and used. Accordingly, the image forming device can implement various accounting policies.

### BRIEF DESCRIPTION OF THE DRAWINGS

The above and other aspects, features and advantages of the present general inventive concept will be more apparent from the following detailed description when taken in conjunction with the accompanying drawings, in which:

FIG. 1 is a block diagram illustrating the configuration of an image forming device according to an exemplary embodiment of the present general inventive concept;

FIG. 2 is a diagram illustrating an example of an accounting application selection screen;

FIG. 3 is a block diagram illustrating the configuration of an accounting apparatus according to another exemplary embodiment of the present general inventive concept;

FIG. 4 is a timing diagram explaining the operation in an accounting manager;

FIG. 5 is a timing diagram explaining the relationship between an accounting manager and an accounting application;

FIG. 6 is a flowchart illustrating an accounting method for an image forming device according to an exemplary embodiment of the present general inventive concept;

FIG. 7 is a flowchart illustrating an accounting application installation and use method for an image forming device according to an exemplary embodiment of the present general inventive concept;

FIG. 8 is a flowchart illustrating an accounting application installation and use method for an image forming device according to another exemplary embodiment of the present general inventive concept;

FIG. 9 is a flowchart illustrating an accounting application installation and use method for an image forming device according to another exemplary embodiment of the present general inventive concept;

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

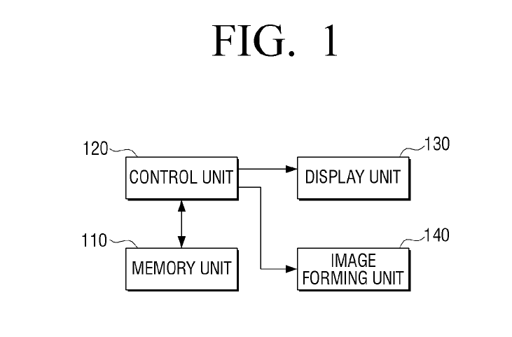

FIG. 1 is a block diagram illustrating the configuration of an image forming device according to an exemplary embodiment of the present general inventive concept. Referring to FIG. 1, the image forming device includes a memory unit 110, a control unit 120, a display unit 130, and an image forming unit 140.

The memory unit 110 stores a platform of the image forming device. Further, the memory unit 110 may store at least one installed accounting application separately from the platform.

The platform of the image forming device may be implemented by an Open Service Gateway initiative (OSGi) platform. The OSGi is the standard that operates under a java Virtual Machine (VM) basis. A framework of the OSGi platform manages one or more OSGi services as a bundle. The framework has a service registry, and thus can perform registration/inquiry/execution/deletion or the like of services.

The image forming device may provide OSGi services using characteristic information that corresponds to the OSGi bundle. The characteristic information refers to an environment setting value that is required to register the OSGi bundle in the OSGi framework. The characteristic information may include service information provided by the OSGi bundle, such as a service name, a service version, and the like, URL information implementing a service engine for the OSGi bundle, user interface (UI) information related to the OSGi bundle, and the like. Here, the UI information is information for informing a user of a name or function of the corresponding service in the form of an icon, and may include position information or the like in which icon data is stored. Further, such characteristic information may be generated using, for example, a Java JAR file that is generated to distribute OSGI bundles in the related art.

Further, the OSGi service means various kinds of functions provided by an OSGi-based device. As described above, in the case where the image forming device has the OSGi-based platform, various kinds of functions provided by a general image forming device, such as faxing, copying, printing, and the like, correspond to the service. In addition, a function of directly transmitting a scan image or a fax document by electronic mail (email), short message service (SMS) and/or multimedia message service (MMS) may be additionally supported through the installation of a corresponding OSGi bundle.

The above-described characteristic information may be provided from a terminal device or a separate server. Further, the characteristic information may be provided in the form of a text (TXT) file or a URL of a web page such as HTML.

Since the OSGi Service Platform Release 3 (OSGi R3) has been announced as of April 2003, further explanation on the structure and function of the OSGi platform used in the image forming device according to the present general inventive concept will be omitted.

As described above, a platform may be provided in the memory unit 110. Further, at least one accounting application may be stored that is installed separately from the platform. That is, if a manufacturer of the image forming device or an application programmer related to accounting has programmed a new accounting application, such accounting application may be installed in the image forming device.

As described above, in the case where the platform is prepared based on OSGi, the accounting application may be prepared with Java. Specifically, the accounting application may be generated in the form of a JAR file that includes resources of software components performed on the OSGi framework, Java Class for operations, manifest files that contain bundle information, and services. Once the accounting application is registered in the OSGi frame network, a bundle context is generated to serve as an interface of the OSGi framework. That is, the interface between the platform and the accounting application (i.e., between bundles). As a result, the accounting application may be stored in an executable state in the memory unit 110 and managed by the accounting manager in the platform.

Although the memory unit 110 is illustrated as one block in FIG. 1, the memory unit 110 may be implemented by various quantities and types of memories for storing the platform and accounting applications. Alternatively, the memory unit 101 may be implemented by a memory that is divided into plural memory areas according to various exemplary embodiments.

Further, the memory unit 110 may store, in addition to various types of application programs and operating systems (O/S) used in the image forming device, various information, such as specifications of the image forming device, use states, print data, scan data, pre-processed data, print history information. The memory unit 110 may be configured to include a volatile memory unit and a non-volatile memory unit.

The volatile memory may be used as a temporary storage space. That is, the volatile memory may be implemented such that the volatile memory temporarily stores print data transmitted from a host PC, free scan data, data scanned for copying, and the like, and then discards the temporarily stored data after the corresponding process is completed. The nonvolatile memory may store various kinds of data or programs in a nonvolatile way.

The display unit 130 displays various information or UI related to the operation or function of the image forming device under the control of the control unit 120. Specifically, the display unit 130 may display information on the accounting applications stored in the storage unit 110.

The image forming unit 140 performs the image forming job under the control of the control unit 120. The image forming job may include, for example, scanning, copying, printing, fax transmission and reception, and the like. That is, the image forming unit 140 may include at least one of a scanner module and a printer module according to the type of the image forming apparatus.

For exemplary purposes, a case where the image forming job is a print job will be described. If a print command is executed in a printer driver or an application installed in a host PC, the printer driver of the host PC generates print data that is obtained by converting the corresponding document into a predetermined print language. Here, the host PC may be a PC that is connected through the image forming device and a local interface. The host PC may also be a terminal device, such as a portable phone, PDA, etc., connected to the image forming device through other wireless communication interfaces. In the case where the host PC is a terminal device, the communication interfaces may include, for example, email, SMS and/or MMS, Bluetooth, Wi-Fi, near field communication (NFC), etc. Further, the communication interfaces may also include any of the various mobile telephone standards, including, for example, Evolved High-Speed Packet Access (HSPA+), 3GPP Long Term Evolution (LTE), Worldwide Interoperability for Microwave Access (WiMAX), Global System for Mobile Communications (GSM), Universal Mobile Telecommunications System (UMTS), code division multiple access (CDMA). Although several example wireless communication interfaces have been discussed, it should be understood that the wireless communication interfaces should not be limited thereto.

If the print data is received through the interface or is read from the memory unit 110, the control unit 120 converts the print data into a bitmap image using a halftone table, and then provides the bitmap image to the print module of the image forming unit 140 to print the bitmap image on a print medium, for example, paper.

The print module may include a print engine controller and plural units for performing the print work. In the case of a laser print type, the units may be a feeder unit, a charging unit, a laser scanning unit, a development unit, a transfer unit, and a fusing unit. In the case of an ink jet print type, the units may be a feeder unit, an ink jet print head, and an ink cartridge. The print engine controller controls the units to perform printing according to the bitmap image provided from the control unit 120.

On the other hand, if a scan command is input, the control unit 120 controls a scanner module (not illustrated) to perform a scan work. The scanner module may include a scanner engine controller, a scanning unit, a scan motor unit, and an image processing unit. The scanner engine controller communicates with the control unit 120, and controls respective components of the scanner module to perform the scan work. The scanning unit serves to scan an object. The scanning unit may be composed of an image reading sensor, a lens, and a light source, and as the image reading sensor, a CCD or CIS image sensor is mainly used. The image reading sensor may include a photoelectric conversion unit that generates charge by absorbing the reflected light of the light that is emitted from the light source and is irradiated onto the object, and a signal detection unit (not illustrated) detecting the charge generated by the photoelectric conversion unit and converting the charge into an electric signal. The electric signal that is converted by the signal detection unit is provided to an image processing unit. The image processing unit generates scan data by performing processes of shading and gamma correction, DPI (Dot Per Inch) conversion, edge emphasis, error diffusion, scaling, and the like, with respect to the image data input from the scanning unit. In this case, the process is appropriately performed in consideration of a pre-designated resolution, a scanning mode, a scanned area, and expansion and reduction ratio.

In addition, in scanning all portions of the paper, the scan motor unit either moves the scanning unit or the paper itself. That is, the object moved by the scan motor unit depends on whether the scanner operation type is a sheet feed type or a flatbed type. For example, in the case of a sheet feed type scanner, the scan motor unit moves the paper, while in the case of a flatbed type scanner, the scan motor unit moves the scanning unit. Further, the scan motor unit may be implemented by a carriage return motor.

If the scan command is delivered, the scanner engine controller scans the object by driving the scanning unit and the scan motor unit, and controls the image processing unit to generate scan data.

The above-described image forming job may be implemented in various ways.

Upon completion of the image forming job, the control unit 120 performs the accounting according to the accounting policy of the selected accounting application. Specifically, if the user inputs the start command for requesting the image forming job, the control unit 120 confirms whether the selected accounting application can perform the accounting for the corresponding image forming job. If it is confirmed that the accounting is possible, the control unit 120 controls the image forming unit 140 to perform the image forming job. Then, the control unit 120 performs the accounting according to the accounting policy of the selected accounting application.

The method of confirming whether the accounting is possible may be implemented in various ways. As an example, information on the accounting policy of the respective accounting applications may be separately stored in the memory unit 110. The accounting policy may be determined based on a printing attribute, the number of working sheets, and work type. That is, in the case of color printing or duplex printing, the accounting may be performed to fix a higher charge than that in the case of normal printing (i.e., monochrome or single-sided printing). The control unit 120 determines that the accounting is not possible if the selected accounting application does not set the accounting policy for the color printing. By contrast, if the accounting policy is prepared, the control unit 120 determines that the accounting is possible. As described above, the control unit 120 can confirm whether the accounting is possible for the attributes set by the respective accounting applications with respect to the corresponding image forming jobs.

Further, the control unit 120 may install a new accounting application at any time. That is, if a new accounting application is provided from, for example, a manager of the image forming device or a third party, the control unit 120 opens and installs the installation execution file in the accounting application. Further, in the platform that is driven by the control unit 120, an accounting manager for managing the accounting application may be prepared. In particular, the accounting manager may verify the installed accounting application and store the verified accounting application in the memory unit 110. During use of the accounting application, the accounting manager displays the all currently installed accounting applications through the display unit 130, thereby allowing the user to select a particular accounting application. Accordingly, the user can perform the image forming job with the accounting policy desired by the user.

The above-described accounting manager may include an accounting manager program or a module that executes the accounting manager program.

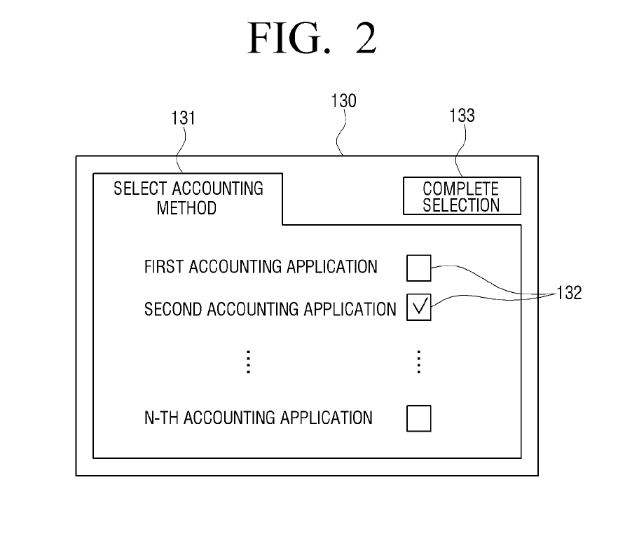

FIG. 2 is a diagram illustrating an example of a selection screen that can select the accounting application. Referring to FIG. 2, the screen of the display unit 130 may display a window 131 for confirming and selecting the accounting method and a menu 133 for indicating the completion of the selection.

Although FIG. 2 illustrates a state where only the name of the accounting application is displayed, the accounting policies of the respective accounting applications may also be displayed. A simple example of the accounting policies may be as shown in the following table.

TABLE 1

| Attributes | First Accounting | Second Accounting |
|---|---|---|
| of Outputs | Application | Application |
| A4 | a | B |
| A3 | a | b * 2 |
| Color Output | a * 2 | b * 3 |
| Duplex Output | a * 2 | B |

In Table 1, a and b refer to basic fees for normal printing for a first and second accounting applications, respectively. According to Table 1, if the first accounting application is selected and an A3/Color/Duplex output is performed, a fee that is four times higher than the basic fee is charged. Similarly, if the second accounting application is selected on the same condition (A3/Color/Duplex), a fee that is five times higher than the basic fee is charged.

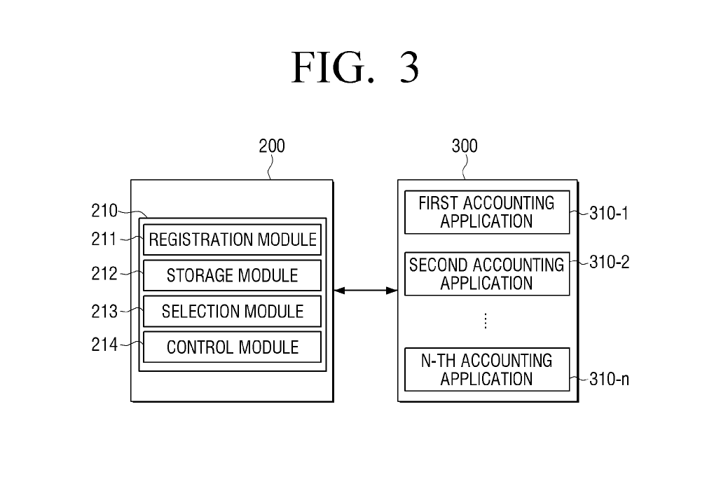

FIG. 3 is a block diagram illustrating the configuration of an accounting apparatus according to another exemplary embodiment of the present general inventive concept. Referring to FIG. 3, the accounting apparatus includes a first storage unit 300 and a second storage unit 200.

The first storage unit 300 may store at least one of accounting applications 310-1 to 310-n. Although FIG. 3 illustrates a state where plural accounting applications are stored, only one accounting application may be installed. Further, at least one of the accounting applications stored in the first storage unit 300 may be prepared by default.

An accounting manager 210 for using the accounting applications may be stored in the second storage unit 200. The accounting manager 210 may be built in the platform.

Referring to FIG. 3, the accounting manager 210 may include a registration module 211, a storage module 212, a selection module 213, and a control module 214.

The registration module 211 requests the storage module 212 to verify the newly installed accounting application and to store the verified accounting application.

The storage module 212 stores the requested accounting application in the memory unit 110.

If there is a request from the selection module 213, the storage module 212 provides information on the stored accounting application to the selection module 213.

When the image forming job starts, or a separate user command is input, the selection module 213 requests the information on the accounting application from the storage module 212. Upon the information being provided, the selection module 213 displays the information through the display unit 130. If the user confirms the displayed information and selects the accounting application, the selection module 213 provides the information on the selected accounting application to the control module 214.

The control module 214 provides the information on the image forming job to the interface that is defined in the selected accounting application. Accordingly, the control module 214 can confirm whether the selected accounting application can perform the accounting for the image forming job.

The interface is defined in the accounting application so that the accounting manager can use the accounting application. In the interface, plural parameters may be defined. As an example, the interface may be implemented as follows.

TABLE 2

| Interface | parameter | description | Return |
|---|---|---|---|
| Start | isColor | Color/Mono Information | Counts |
| | PlexUsed | Simplex/Duplex | |
| | | Information | |
| | JobType | Print or Copy Job | |
| | Size | Output Paper Size | |

According to Table 2, the interface may include a first parameter reporting whether the present mode is a color mode or a mono mode, a second parameter reporting whether the present mode is a simplex mode or a duplex mode, a third parameter reporting a job type, and a fourth parameter reporting a size of outputs. Further, the all of the parameters may be reported, or only a portion of the parameters may be used.

Before starting the image forming job, the accounting manager provides, for example, four parameter values that are defined in the above-described interface to the accounting application. Accordingly, the accounting application returns the counted value that can be output based on each of the provided parameters. That is, the accounting manager determines whether the accounting is possible based on the reported values. If the counted value is equal to or larger than 1, it is it is determined that the accounting is possible, and the output as large as the counted value can be performed.

If the image forming job is performed, the accounting manager provides output count information, which includes the number of output sheets, the number of image, and the like, to the accounting application. In this case, parameters that are defined in another interface of the accounting application may be used.

TABLE 3

| interface | Parameter | Description | Return |
|---|---|---|---|
| PaperOut | Count | Number of | N/A |
| | | Output Sheets | |

The accounting application performs the accounting to suit its accounting policy through confirming of the parameter values described in Table 3. The output count information may be provided whenever the printing of each page is completed, and may be provided when the printing of all of the pages has been completed.

If the image forming job is completed, the accounting manager may report the completion of the image forming job. An interface that reports such information may be defined as in the following table.

TABLE 4

| interface | Parameter | Description | Return |
|---|---|---|---|
| JobComplete | N/A | N/A | N/A |

As described in Table 4, the completion of the image forming job is reported to the accounting application. Conversely, if the accounting application is in a state where the accounting is not possible, it may be reported to the accounting application through an interface such as JobCancel.

The accounting apparatus in FIG. 3 may be prepared separately from the image forming device, or may be mounted inside the image forming device. Further, although FIG. 3 illustrates that the accounting manager and the accounting applications are stored in different storage units, the storage units may be within the same physical memory. That is, the respective programs may be stored in different storage areas in the same memory. Conversely, the accounting manager and the accounting applications may be stored in a plurality of different memory devices.

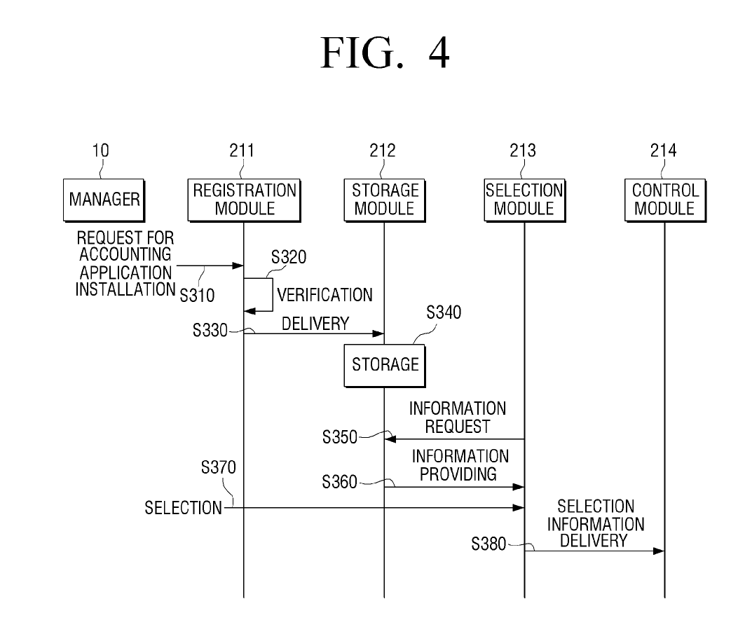

FIG. 4 is a timing diagram explaining a process of installing and using the accounting application. Referring to FIG. 4, a manager 10 may input an installation request while it transmits the accounting application to the image forming device or the accounting apparatus (S310). Specifically, various recording media, for example, a memory card, USB, or CD, in which the accounting application is stored, may be inserted or loaded into the device, or the accounting application may be downloaded from an external server, and then the accounting application may be installed through selection of the installation execution file.

Similarly, the accounting application may be transferred from a mobile device, such as a cellular phone, PDA, tablet, etc. to the image forming device. In this case, the accounting application may be transferred via various communication interfaces, including, for example, email, SMS and/or MMS, Bluetooth, Wi-Fi, NFC, etc. Further, the transfer may be performed using any of the various mobile telephone standards, including, for example, HSPA+, 3GPP, LTE, WiMAX, GSM, UMTS, CDMA, etc. Although several example wireless communication interfaces have been discussed, it should be understood that the wireless communication interfaces should not be limited thereto.

Following receipt of the installation request, the registration module 211 verifies the corresponding accounting application (S320). Upon completion of the verification, the accounting application is delivered to the storage module 212 (S330). Here, the term “verification” refers to a process of deciding whether the accounting manager of the platform is a usable program by confirming the producer of the accounting application, version information, and the like.

The storage module 212 stores the delivered accounting application (S340). Accordingly, the accounting application can be updated any time, and can be newly added.

The selection module 213 request the information on the previously installed accounting application from the storage module 212 when the image forming job starts, a user's request is input, or a user setting environment is changed (S350).

Following the request for the information, the information is provided (S360). The selection module 213 then selects one of the accounting applications. The selection of the accounting application may be made by the manager 10. That is, if the manager 10 selects one of the displayed information (S370) after the information provided from the storage module 212 has been displayed, the selection module 213 provides the selected information to the control module 214 (S380).

The control module 214 performs the accounting for the image forming job by using the selected accounting application. That is, the control module 214 provides information related to the consumption amount of supplies (toner, paper, etc.) to the accounting application, and enables the accounting application to perform the accounting to suit the accounting policy.

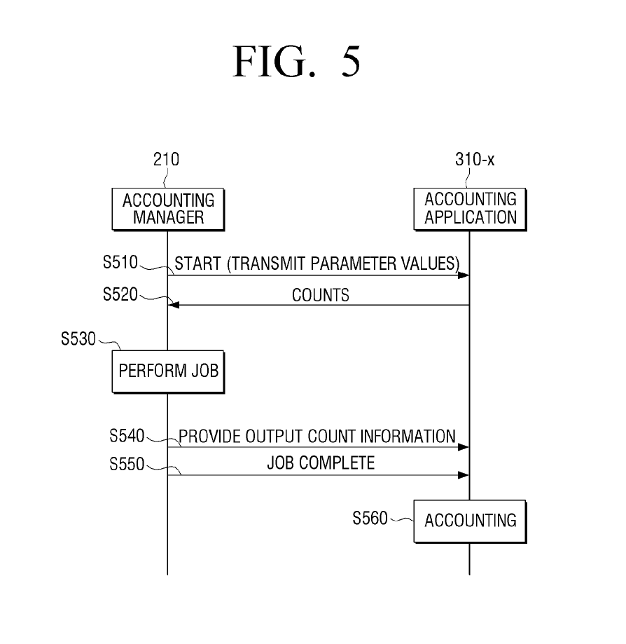

FIG. 5 is a timing diagram illustrating the operation between the accounting manager 210 and the selected accounting application 310-x. Referring to FIG. 5, the accounting manager 210 transmits parameter values defined in the “start” interface as shown in Table 2 (S510). The accounting application 310-x receives the attribute of the image forming job by confirming the transmitted parameter values, and then decides whether its accounting policy supports the corresponding attributes. Then, the accounting application transmits a “count” value that reports whether the accounting is possible according to the result of decision (S520). In particular, as discussed above, it is determined that the accounting is possible if the count value is equal to or larger than 1.

If it is decided that the accounting is possible according to the count value, the accounting manager 210 performs the image forming job (S530). Then, according to the result of performing of the image forming job, the accounting manager 210 provides the output count information (S540). Thereafter, if the image forming job is completed, the accounting manager reports that the job has been completed (S550).

If the job is completed, the accounting application performs the accounting (S560). The result of accounting may be displayed on the screen through the display unit or may be output onto the paper. Further, the result of accounting may be reported by sending a short message (SMS) to a user's portable phone, PDA, tablet, etc. or by sending an email to the user. It should be understood that the accounting may be reported through other various communication interfaces, including MMS and any of the various wireless standards as discussed above.

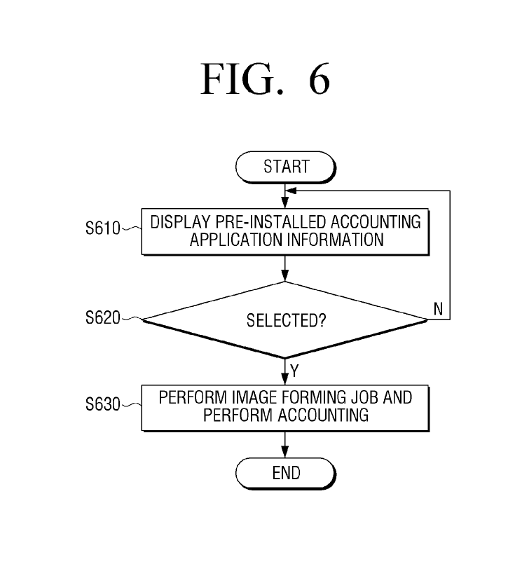

FIG. 6 is a flowchart illustrating an accounting method for an image forming device according to an exemplary embodiment of the present general inventive concept. Referring to FIG. 6, in the image forming device, at least one accounting application may be installed separately from the platform. Accordingly, information on the previously installed accounting applications is displayed (S610) for selection by a user.

Upon selection of an accounting application (S620), the image forming device performs the image forming job, and performs the accounting by using the selected accounting application (S630).

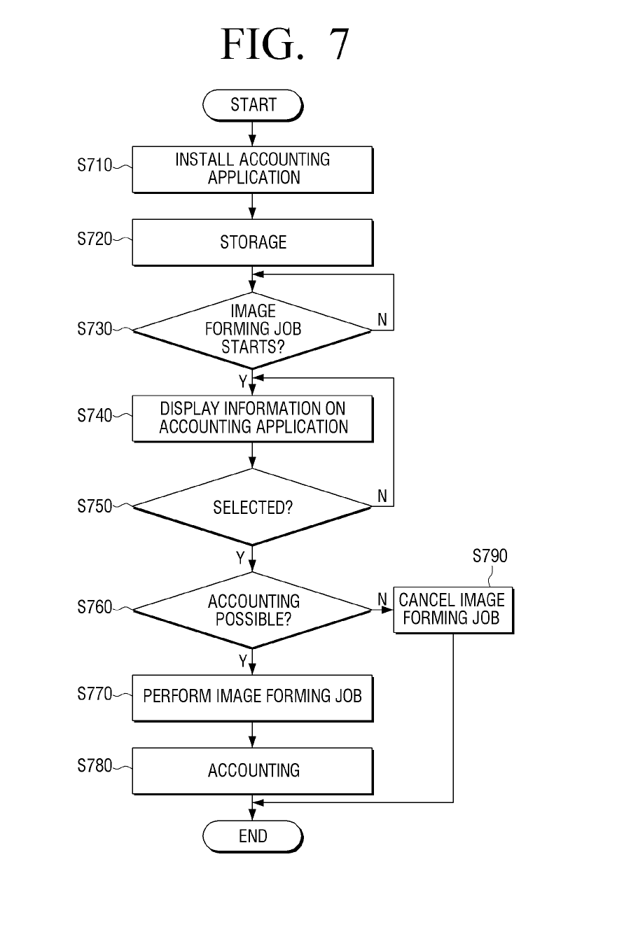

FIG. 7 is a flowchart illustrating an accounting method according to another exemplary embodiment of the present general inventive concept. In FIG. 7, if an accounting application is installed (S710), it is stored in the memory unit 110 (S720). If the image forming job is started (S730), information on the installed accounting applications is displayed (S740). The user may then select a desired accounting application from the various installed accounting applications (S750). Following selection by the user, it is confirmed whether it is possible for the selected accounting application to perform the accounting (S760).

Specifically, it can be confirmed whether the selected accounting application can support the output according to the corresponding image forming job through transmission of at least one parameter value that is defined in the accounting application.

Accordingly, if the accounting is possible, the image forming job is performed (S770), and if the image forming job is completed, count information is output to the selected accounting application to facilitate the performance of the accounting (S780). The result of accounting may be reported in various ways as described above.

Conversely, if it is determined that the accounting is not possible, the image forming device may cancel the image forming job (S790). Accordingly, if the user intends to perform the corresponding image forming job, the user can select another accounting application from the various installed accounting applications by inputting a start command for the image forming job.

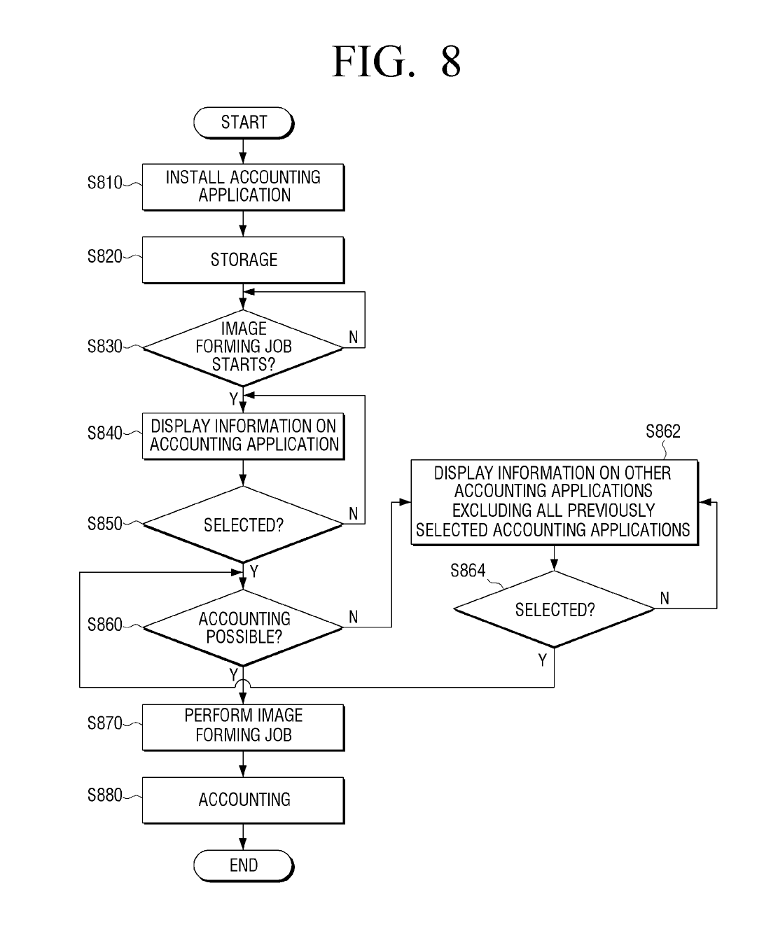

FIG. 8 is a flowchart illustrating an accounting method according to another exemplary embodiment of the present general inventive concept. In FIG. 8, discussion with respect to similar steps described above with respect to FIG. 7 will be omitted. In FIG. 8, if it is determined that the accounting is not possible (S860), the information on the various accounting applications may be redisplayed to allow the user to directly re-select another accounting application of the various installed accounting applications (S862). In this case, the information on the previously selected accounting application is excluded from being displayed, thereby preventing the user from selecting the previously selected accounting application.

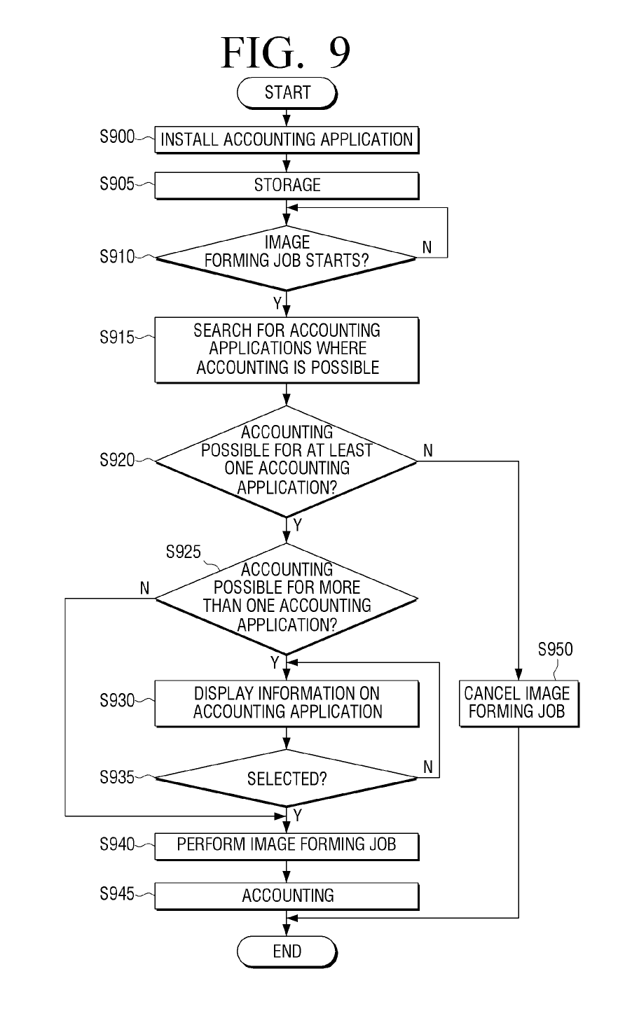

FIG. 9 is a flowchart illustrating an accounting method according to another exemplary embodiment of the present general inventive concept. In FIG. 9, discussion with respect to similar steps described above with respect to FIGS. 7 and 8 will be omitted. In FIG. 9, the image forming device may search for accounting applications in which the accounting for the corresponding image forming job is possible (S915). If it is determined that there are no accounting applications in which the accounting for the corresponding image forming job is possible, the image forming device may cancel the image forming job (S950). If there is only one usable accounting application (no at S925), the image forming device automatically performs the image forming job (S940). If it is determined that there is more than one accounting applications in which the accounting for the corresponding image forming job is possible, information on the installed accounting applications is displayed (S930).

The accounting methods and the accounting application installation methods according to various exemplary embodiments of the present general inventive concept, as described above, may be stored in various types of recording media, and may be implemented by program codes that can be executed by CPUs provided in various types of electronic devices.

Specifically, codes for performing the above-described methods may be stored in various types of recording media that can be read by terminals, such as a RAM (Random Access Memory), flash memory, ROM (Read Only Memory), EPROM (Erasable Programmable ROM), EEPROM (Electrically Erasable and Programmable ROM), register, hard disk, solid-state disk (SSD), removable disk, memory card, USB memory, CD-ROM, and the like.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An accounting method for an image forming device comprising:
installing at least one accounting application in the image forming device;
storing information on the installed at least one accounting application in a storage unit by an accounting manager provided on a platform of the image forming device;
displaying information corresponding to the at least one accounting application stored in the storage unit;
receiving a selection of an accounting application from among the displayed information corresponding to the at least one accounting application installed in the image forming device; and
performing an accounting operation for an image forming job according to an accounting policy of the selected accounting application from among the at least one accounting application upon performance of the image forming job.

2. The accounting method as claimed in claim 1, wherein the displaying information and the receiving the selection are performed upon the initialization of the image forming job, and the accounting operation is performed in the selected accounting application upon the determination that the accounting operation for the image forming job is available.

3. The accounting method as claimed in claim 2, wherein the accounting manager provides information on the image forming job through an interface defined in the accounting application to provide confirmation from the accounting application that the accounting operation for the image forming job is possible.

4. The accounting method as claimed in claim 3, wherein the interface includes at least one parameter among a first parameter reporting whether the present mode is a color mode or a mono mode, a second parameter reporting whether the present mode is a simplex mode or a duplex mode, a third parameter reporting a job type, and a fourth parameter reporting a print medium size.

5. The accounting method as claimed in claim 3, wherein the step of performing the image forming job comprises:
the accounting manager delivering at least one parameter value that is included in the interface to the selected accounting application;
the selected accounting application determining whether the accounting operation for the image forming job is possible on the basis of the at least one parameter value and reporting a result of the determination to the accounting manager; and
if it is determined that the accounting operation is possible, providing output count information to the selected accounting application during performance of the image forming job, and if it is determined that the accounting operation is not possible, canceling the image forming job.

6. An accounting method for an image forming device comprising:
displaying information corresponding to at least one accounting application installed to an external location located outside of a platform built in the image forming device;
performing an image forming job following selection of an accounting application from among the displayed information corresponding to the at least one accounting application; and
performing an accounting operation according to an accounting policy of the selected accounting application from among the at least one accounting application.

7. The accounting method as claimed in claim 6, wherein the step of performing the image forming job comprises:
the selected accounting application confirming whether the accounting operation for execution of an option of the image forming job is possible by providing at least one parameter value to the selected accounting application according to the option of the image forming job; and
if the accounting operation is possible, performing the image forming job, and if the accounting is not possible, canceling the image forming job.

8. The accounting method as claimed in claim 6, wherein the step of performing the image forming job comprises:
the selected accounting application confirming whether the accounting operation for execution of an option of the image forming job is possible by providing at least one parameter value to the selected accounting application according to the option of the image forming job; and
if the accounting is possible, performing the image forming job, and if the accounting is not possible, receiving a reselection following the display of information corresponding to at least one other accounting application of the at least one accounting application, wherein the display of information corresponding to the selected accounting application is excluded.

9. The accounting method as claimed in claim 7, wherein the parameter includes at least one parameter among a first parameter reporting whether the present mode is a color mode or a mono mode, a second parameter reporting whether the present mode is a simplex mode or a duplex mode, a third parameter reporting a job type, and a fourth parameter reporting a print medium size.

10. An image forming device comprising:
a memory unit to store a platform of the image forming device and, if at least one accounting application is installed separately from the platform, storing the installed accounting application;
a display unit to display information corresponding to accounting applications stored in the memory unit and to receive a selection of one accounting application from among the displayed information corresponding to the account applications;
an image forming unit to perform an image forming job; and
a control unit to perform an accounting operation according to an accounting policy of the selected accounting application upon completion of the image forming job.

11. The image forming device as claimed in claim 10, wherein the control unit confirms whether the selected accounting application can perform the accounting operation for the image forming job if a start command for the image forming job is input, and performs the accounting operation while performing the image forming job if the accounting is possible.

12. An image forming device comprising:
a storage unit to store a plurality of accounting applications and an accounting manager to support the plurality of accounting applications;
wherein the accounting manager performs an accounting operation for an image forming job using an accounting application selected among the plurality of accounting applications upon performance of the image forming job.

13. The image forming device as claimed in claim 12, wherein the accounting manager provides information on the image forming job using an interface defined in the selected accounting application, confirms whether the selected accounting application can perform the accounting operation for the image forming job, and if the accounting is possible, provides output count information to the selected accounting application upon completion of the image forming job.

14. The image forming device as claimed in claim 13, wherein the accounting manager delivers at least one parameter value that is defined in the interface to the selected accounting application;
the selected accounting application determines whether the accounting operation for the image forming job is possible on the basis of the at least one parameter value, and reports a result of the determination to the accounting manager, and
the at least one parameter includes at least one of a first parameter reporting whether the present mode is a color mode or a mono mode, a second parameter reporting whether the present mode is a simplex mode or a duplex mode, a third parameter reporting a job type, and a fourth parameter reporting a print medium size.

15. A computer-readable recording medium for storing a program code for executing an accounting method for an image forming device, the accounting method comprising:
storing an installed accounting application if the installed accounting application has been installed separately from a platform of the image forming device;;
displaying information on the installed accounting application and previously stored accounting applications upon initialization of an image forming job starts;
confirming whether an accounting operation for the image forming job is possible following selection of an accounting application among the displayed information corresponding to the installed accounting application and the previously stored accounting applications;
performing the image forming job upon a determination that the accounting operation is possible; and
performing the accounting operation according to an accounting policy of the selected accounting application upon completion of the image forming job.

16. The recording medium as claimed in claim 15, wherein the step of confirming whether the accounting operation is possible comprises:
an accounting manager built in the platform delivering at least one parameter value that is defined in an interface of the selected accounting application to the selected accounting application; and
the selected accounting application determining whether the accounting operation for the image forming job is possible on the basis of the at least one parameter value and reporting a result of the determination to the accounting manager program;
wherein the at least one parameter includes at least one of a first parameter reporting whether the present mode is a color mode or a mono mode, a second parameter reporting whether the present mode is a simplex mode or a duplex mode, a third parameter reporting a job type, and a fourth parameter reporting a print medium size.

17. An accounting method for an image forming device comprising:
installing and storing a plurality accounting applications in the image forming device;
displaying information corresponding to the plurality of accounting applications;
selecting a first accounting application from among the displayed information corresponding to the plurality of accounting applications;
determining whether a first accounting operation may be performed for the selected first accounting application; and
performing the first accounting operation according to an accounting policy of the selected first accounting application upon the determination that the first accounting operation may be performed and upon performance of an image forming job.

18. The accounting method as claimed in claim 17, wherein, upon the determination that the first accounting operation may not be performed, redisplaying information corresponding to the plurality of accounting applications and excluding the display of the information corresponding to the selected first accounting application.

19. The accounting method as claimed in claim 18, wherein the method further comprises:
selecting of a second accounting application from among the redisplayed information corresponding to the plurality of accounting applications excluding the first accounting application;
determining whether a second accounting operation may be performed for the selected second accounting application; and
performing the second accounting operation according to an accounting policy of the selected second accounting application upon the determination that the second accounting operation may be performed and upon performance of the image forming job.

20. An accounting method for an image forming device comprising:
installing and storing a plurality accounting applications in the image forming device;
searching for accounting applications among the plurality of stored accounting applications having corresponding accounting operations capable of being performed;
determining, based on the searching among the plurality of stored accounting applications, a number of the accounting applications among the plurality of stored accounting applications having corresponding accounting operations capable of being performed;
selecting an accounting application from among the plurality of stored accounting applications having corresponding accounting operations capable of being performed; and
performing an accounting operation corresponding to the selected accounting application according to an accounting policy of the selected accounting application following performance of an image forming job.
